(19) United States
(12) Patent Application Publication
(10) Pub. No.: US 2004/0156074 A1
(43) Pub. Date: Aug. 12, 2004

(54) Method of and apparatus for printing data using identification number of printer

(75) Inventor: Byoung-Yue Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/770,396

(22) Filed: Feb. 4, 2004

(30) Foreign Application Priority Data
Feb. 6, 2003 (KR) 2003-7434

(51) Int. Cl. G06F 15/00; H04N 1/00

(52) U.S. Cl. 358/1.15; 358/401; 358/1.14

(57) ABSTRACT

A method of printing data using an identification number of a printer to perform a printing process through a network in which a plurality of printers are respectively connected to a plurality of computers, including: receiving identification numbers of each of the printers; receiving a network address of a selected printer corresponding to a predetermined identification number from among the received identification numbers; and transmitting print data to the selected printer to perform the printing process.

### CROSS-REFERENCE TO RELATED APPLICATIONS

This application claims the priority of Korean Patent Application No. 2003-7434 filed on Feb. 6, 2003 in the Korean Intellectual Property Office, the disclosure of which is incorporated herein in its entirety by reference.

### BACKGROUND OF THE INVENTION

1. Field of the Invention

The present invention relates to a method of and apparatus for performing a printing process in an environment in which a plurality of printers are connected to a plurality of computers through a network, and more particularly, to a method and apparatus for printing data using an identification number of a printer.

2. Description of the Related Art

A printer can be used by a computer as a local printer or as a network printer. A network printer is a printer connected to a computer through a network. The network printer connected to computers through a network is commonly used by the computers. To transmit data from one computer to the network printer via the network, a printer port must be set in the computer so that data can be transmitted between the network printer and the computer. When the printer port is set in the computer, information provided by the network printer includes a network address. The network address includes an Internet protocol (IP) address, a media access control (MAC) address, or an internetwork packet exchange (IPX) address. An IP address consists of a bit stream of 32 bits is an address to identify a data transmitting source and a data receiving source during TCP/IP (transmission control protocol/Internet protocol) communication. A MAC address is a physical address of Ethernet and has a size of 48 bits. An IPX address is a protocol which is not reliable in data transmission between a destination and a transmission place. A variety of protocols are used in an upper level of the IPX address. The network address is transmitted from the network printer to the computer when the printer port is set and stored in the computer. When a user requests a predetermined computer to perform a printing process via a local printer attached thereto, the computer transmits print data to the predetermined printer corresponding to the network address received from the printer and stored in the computer. Thereafter, the printer receives the print data and performs the printing process.

However, when the network address of the network printer is changed after the printer port is set, the network address stored in the computer is different from the network address of the network printer. Thus, when the user requests a printing process, the computer transmits print data to a network address corresponding to the previously set printer port. Since the network address corresponding to the previous printer port has already been changed in the network printer, the print data cannot be transmitted to a corresponding network printer and a print error is generated. Therefore, when the network address of the network printer is changed, the user needs to inconveniently delete the previous printer port and reset the printer port by receiving a changed network address from the network printer.

### SUMMARY OF THE INVENTION

To solve the above and/or other problems, the present invention provides a method of printing data using an identification number of a printer in which an identification number of a printer instead of a network address is provided as registration information of a printer port and printing is performed by receiving a network address corresponding to the identification number.

Also, the present invention provides an apparatus for printing data using an identification number of a printer by storing an identification number of a printer instead of a network address as registration information of a printer port and receiving a network address corresponding to the identification number to perform a printing process.

Additional and/or other aspects and advantages of the invention will be set forth in part in the description which follows and, in part, will be obvious from the description, or may be learned by practice of the invention.

According to an aspect of the present invention, there is provided a method of printing data using an identification number of a printer to perform a printing process through a network in which a plurality of printers are respectively connected to a plurality of computers, including: receiving identification numbers of each of the printers; receiving a network address of a selected printer corresponding to a predetermined identification number from among the received identification numbers; and transmitting print data to the selected printer to perform the printing process.

According to another aspect of the present invention, there is provided an apparatus for printing data using an identification number of a printer to perform a printing process through a network in which a plurality of printers are respectively connected to a plurality of computers through a network, including: a port setting portion which requests the printers to transmit identification numbers in response to a printer port set request and which stores the received identification numbers; an identification number transmitting portion which transmits the requested identification numbers; a request signal generating portion which generates an address request signal requesting a network address of a specific printer among the printers in response to a print request and which outputs the generated address request signal; an address transmitting portion which transmits the network address in response to the address request signal; an address receiving portion which the transmitted network address; a data transmitting portion which transmits print data to the specific printer; and a print portion which prints the transmitted print data.

According to yet another aspect of the present invention, there is provided a method of printing data over a network, including: determining a corresponding printer by generating an address request signal which includes specifying identification information, transmitting the address requesting signal to printers connected to the network, checking whether the specifying identification information matches printer identification information of a printer connected to the network, a printer having printer identification information which matches the specifying identification information being the corresponding printer; and transmitting print data to the corresponding printer.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart for explaining a method of printing data using an identification number of a printer according to an embodiment of the present invention;

FIG. 2 is a flow chart for explaining sub-steps of the step 12 of FIG. 1 according to an embodiment of the present invention;

FIG. 3 is a block diagram illustrating an apparatus for printing data using an identification number of a printer according to an embodiment of the present invention; and

FIG. 4 is a block diagram illustrating the address transmitting portion shown in FIG. 3 according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

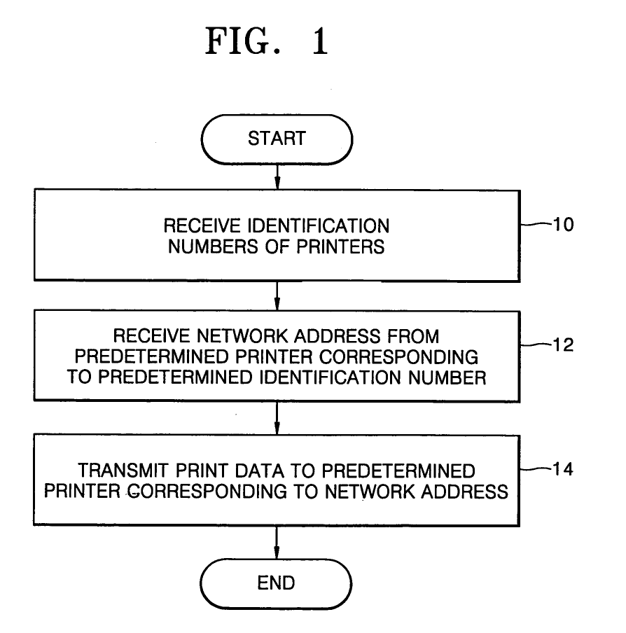

Referring to FIG. 1, a method of printing data using an identification number of a printer according to a first embodiment of the present invention is performed by receiving a network address of a specific network printer corresponding to a predetermined identification number and transmitting print data using the received network address to perform a printing process (operations 10-14).

First, identification numbers of printers are received from printers as registration information of a printer port (operation 10). A plurality of printers are connected to a plurality of computers through a network. Printer ports of the printers are set in each of the computers. The identification number is an independent sign which is permanent and identifies each of the printers. For example, a printer manufacturer serial number is usable as the identification number. In contrast to the conventional art, in which a network address was provided from the printer as registration information of the printer port, in the present embodiment, when the printer port is set, the identification number of a printer, not the network address, is provided.

After operation 10, a network address of a specific printer is received from the specific printer corresponding to a predetermined identification number (operation 12). Upon request of a user, a network address of the specific printer to perform a printing process is received.

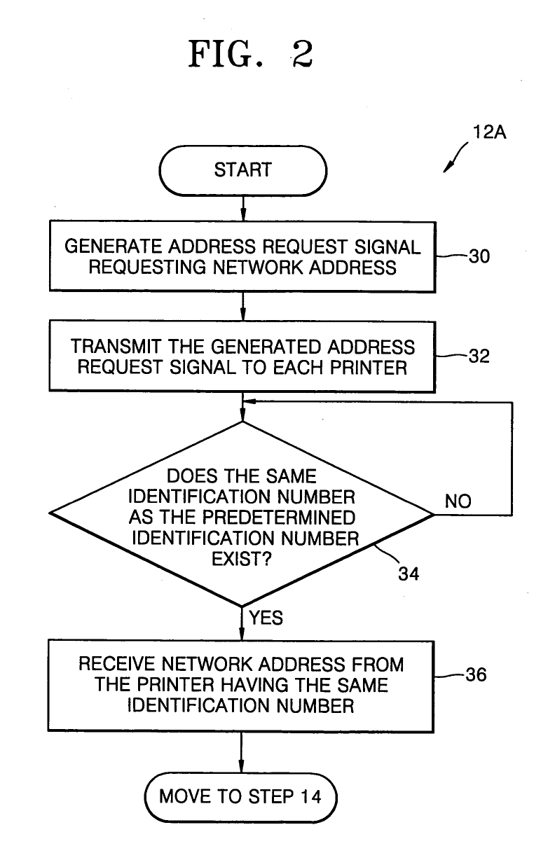

FIG. 2 is a flowchart for explaining an embodiment (12A) of the present invention with respect to operation 12 of FIG. 1, which includes operations of transmitting a generated address request signal and receiving a network address.

First, upon request of a user, an address request signal having a predetermined identification number and requesting a network address is generated (operation 30). That is, when the user requests a predetermined printer to print, an address request signal is generated as a signal requesting a network address of a predetermined printer. The network address is, by way of non-limiting examples, an IP address, a MAC address, or IPX address.

A printer port corresponding to the specific printer has an identification number of the printer as registration information in advance. When the address request signal is generated, the identification number of the printer stored in the registration information of the printer port is included in the address request signal.

After operation 30, the generated address request signal is transmitted to the respective printers (operation 32). That is, the address request signal is transmitted to all of the printers connected to the network.

After operation 32, it is determined whether there is the same identification number as the identification number included in the transmitted address request signal of the (operation 34). Each of the printers receiving the address request signal has its own identification number. Also, the address request signal has the identification number. Thus, each printer compares the identification number included in the received request signal with its own identification number and determines whether the identification numbers match.

When no match of identification numbers is made, the comparing of the identification numbers continues until the same identification number is found.

However, when there is an identification number of each of the printers matching the identification number included in the received address request signal, the network address is received from the printer having the identification number (operation 36). That is, if there is a printer having the same identification number as the identification number included in the received address request signal, a network address of the printer needed for print is transmitted to the computer.

After operation 12, print data is transmitted to the printer corresponding to the received network address and then printing is performed (operation 14). The computer receiving the network address of the printer transmits the print data which is previously in the possession of the printer using the received network address.

The printer prints the received print data corresponding to the print request by the user.

An apparatus for printing data using an identification number of a printer according to an embodiment of the present invention will now be described.

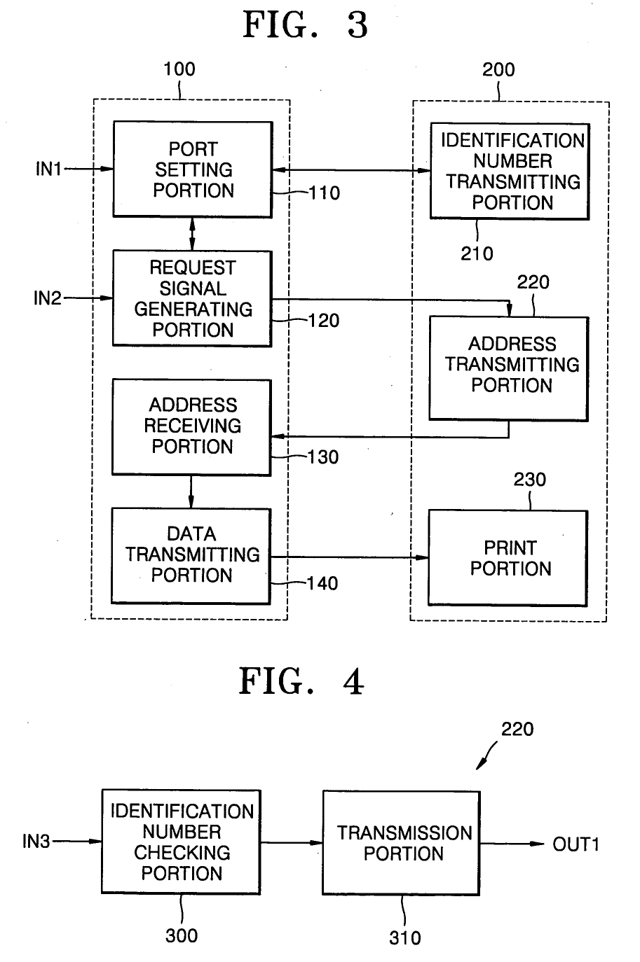

FIG. 3 is a block diagram illustrating an apparatus for printing data using an identification number of a printer according to an embodiment of the present invention. The apparatus includes a computer 100 and a printer 200 connected via a network. While only one computer and one printer are shown and described in FIG. 3, it is to be understood that other computers and printers can be connected to the network. Such other computers and printers have the same structures as those of the computer 100 and the printer 200.

The computer 100 includes a port setting portion 110, a request signal generating portion 120, an address receiving portion 130, and a data transmitting portion 140. The printer 200 includes an identification number transmitting portion 210, an address transmitting portion 220, and a print portion 230.

In response to a printer port set request, the port setting portion 110 of the computer 100 requests an identification number of the printer 200 as a registration number of a printer port and stores received identification numbers. For example, in response to a printer port set request input through an input port IN1, the port setting portion 110 requests the identification number transmission portion 210 of the printer 200 to transmit an identification number of the printer 200 as registration information of a printer port. The identification number to be transmitted by the identification number transmission portion 210 is a permanent and independent sign capable of distinguishing the printer 200 from the other printers, for example, a manufacturer serial number of the printer 200.

The port setting portion 110 receives an identification number transmitted from the identification number transmitting portion 210 and stores the identification number.

The identification number transmitting portion 210 transmits the identification number requested by the port setting portion 110. For example, the identification number transmitting portion 210 receives a signal requesting an identification number from the port setting portion 110 of the computer 100 and transmits a manufacturer serial number corresponding to the identification number of the printer 200 to the port setting portion 110 in response to the request signal.

The request signal generating portion 120 in response to the request of a user generates an address request signal requesting a network address of the printer 200 which is one of a plurality of printers, and outputs a generated address request signal. The network address is, by way of non-limiting examples, an IP address, a MAC address, or an IPX address as described above.

When a user's print request for the printer 200 to perform a printing process is received through an input port IN2, the request signal generating portion 120 in response to the request generates an address request signal requesting a network address of the printer 200. The request signal generating portion 120 draws a predetermined identification number of the registration information of a printer port of the printer 200 from the port setting portion 110 and adds the drawn identification number to the address request signal. The request signal generating portion 120 outputs the address request signal, to which the identification number is added, to the address transmitting portion 220 of the printer 200 and to other printers (not shown).

The address transmitting portion 220 transmits a network address in response to the address request signal. The address transmitting portion 220 provided in each printer transmits a network address of the printer 200 to the address receiving portion 130 of the computer 100 in response to the address request signal transmitted from the request signal generating portion 120 of the computer 100.

FIG. 4 is a block diagram illustrating an address transmitting portion 220 according to an embodiment of the present invention. The address transmitting portion 220 includes an identification number checking portion 300 and a transmission portion 310.

The identification number checking portion 300 in response to the address request signal having a specific identification number checks whether the identification number of the printer 200 having the address transmitting portion 220 is the same as the specific identification number and outputs the checking result as a check signal. Each of the printers receiving the address request signal has its own identification number. Thus, each printer compares its own identification number and the specific identification number included in the address request signal to check whether the identification numbers are identical.

The identification number checking portion 300 receives the address request signal from the request signal generating portion 120 through an input port IN3. In response to the received address request signal, the identification number checking portion 300 checks whether the identification number of the printer 200 having the address transmitting portion 220 is the same as the specific identification number added to the transmitted address request signal and outputs the checking result to the transmission portion 310 as a check signal. If the identification number of the printer 200 and the specific identification number are the same, the printer that a user requests to perform a printing process is accurately searched for by the check performed by the identification number checking portion 300.

The transmission portion 310 in response to the check signal transmits the network address of the printer having the same identification number. That is, the transmission portion 310 in response to the check signal output from the identification number checking portion 300 transmits the network address of the printer 200 having the same identification number as that added to the address request signal to the address request portion 130 of the computer 100 through an output port OUT1.

The address receiving portion 130 receives the network address that is transmitted. That is, the address receiving portion 130 receives the network address of the printer 200 transmitted from the address transmitting portion 220 and outputs the received network address to the data transmitting portion 140.

The data transmitting portion 140 transmits print data to the printer 200 corresponding to the received network address. That is, the data transmitting portion 140 receives the network address of the printer 200 from the address receiving portion 130 and, in response to the above, transmits print data to the printer 200 corresponding to the received network address.

The print portion 230 prints the received print data. The print portion 230 is provided in the printer 200 corresponding to the network address. The printer portion 230 prints the received print data according to the user's print request.

As described above, in the method and apparatus for printing data using an identification number of a printer according to the described embodiments of the present invention, when a printer port of a printer connected to a computer via a network is set in the computer, an identification number of the printer is received instead of a network address as registration information of the printer port; thus, even when the network address of the printer is changed, the printer port does not need to be reset and the already set printer port is still usable to perform a printing process.

Although a few embodiments of the present invention have been shown and described, the present invention is not limited to the described embodiments. Rather, it would be appreciated by those skilled in the art that changes may be made in these embodiments without departing from the principles and spirit of the invention, the scope of which is defined by the claims and their equivalents.

What is claimed is:

1. A method of printing data using an identification number of a printer to perform a printing process through a network in which a plurality of printers are respectively connected to a plurality of computers, comprising:
receiving identification numbers of each of the printers;
receiving a network address of a selected printer corresponding to a predetermined identification number from among the received identification numbers; and
transmitting print data to the selected printer to perform the printing process.

2. The method of claim 1, wherein the receiving a network address comprising:
generating an address request signal having the predetermined identification number and requesting the network address upon a user's print request;
transmitting the address request signal to each of the printers;
determining whether one of the identification numbers is the same as the predetermined identification number; and
receiving the network address from the selected printer when the identification number is the same as the predetermined identification numbers.

3. The method as claimed in claim 1, wherein the network address is one of an Internet protocol (IP) address, an Internet packet exchange (IPX) address, and a media access control (MAC) address.

4. The method of claim 1, wherein, in the determining, each printer compares the predetermined identification number included in the transmitted address request signal to its own identification number.

5. The method of claim 1, wherein the identification numbers are printer port registration information.

6. The method of claim 1, wherein the identification numbers are printer serial numbers.

7. An apparatus for printing data using an identification number of a printer to perform a printing process through a network in which a plurality of printers are respectively connected to a plurality of computers, comprising:
a port setting portion which requests the printers to transmit identification numbers in response to a printer port set request and which stores the received identification numbers;
an identification number transmitting portion which transmits the requested identification numbers;
a request signal generating portion which generates an address request signal requesting a network address of a specific printer among the printers in response to a print request and which outputs the generated address request signal;
an address transmitting portion which transmits the network address in response to the address request signal;
an address receiving portion which the transmitted network address;
a data transmitting portion which transmits print data to the specific printer; and
a print portion which prints the transmitted print data.

8. The apparatus of claim 7, wherein the address request signal includes an identification number corresponding to the specific printer.

9. The apparatus as claimed in claim 7, wherein the address transmitting portion comprises:
an identification number checking portion checking whether an identification number of a printer having the address transmitting portion and the predetermined identification number are the same, in response to the address request signal having the predetermined identification number, and outputting the result of check as a check signal; and
a transmission portion transmitting the network address of the predetermined printer having the same identification number in response to the check signal.

10. The apparatus of claim 7, wherein the network address is one of an Internet protocol (IP) address, an Internet packet exchange (IPX) address, and a media access control (MAC) address.

11. The apparatus of claim 7, wherein the identification numbers are printer port registration information.

12. The apparatus of claim 7, wherein the identification numbers are printer serial numbers.

13. A method of printing data over a network, comprising:
determining a corresponding printer by generating an address request signal which includes specifying identification information, transmitting the address requesting signal to printers connected to the network, checking whether the specifying identification information matches printer identification information of a printer connected to the network, a printer having printer identification information which matches the specifying identification information being the corresponding printer; and
transmitting print data to the corresponding printer.

14. The apparatus of claim 13, wherein, in the determining, each printer compares the predetermined identification number included in the transmitted address request signal to its own identification number.
